(19) United States
(12) Patent Application Publication
(10) Pub. No.: US 2009/0071813 A1
(43) Pub. Date: Mar. 19, 2009

(54) METHOD FOR CHEMICALLY REACTING AND SEPARATING A MIXTURE IN A COLUMN

(75) Inventors: York Alexander Beste, Speyer (DE); Markus Eggersmann, Mannheim (DE); Hartmut Schoenmakers, Dossenheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/719,797

(22) PCT Filed: Nov. 21, 2005
(86) PCT No.: PCT/EP2005/012426

§ 371 Date: May 21, 2007

(30) Foreign Application Priority Data
Nov. 24, 2004 (DE) 10 2004 056 672.0

(51) Int. Cl. B01D 3/40; B01D 3/34

(52) U.S. Cl. 203/32; 203/29

(57) ABSTRACT

Processes for chemical reaction and separation in a column comprising, (a) providing one or more reactants to a column; and (b) carrying out at least partially superimposed reactive distillation and extractive distillation on the one or more reactants in the column to form a reaction product mixture comprising at least two components and separate at least one of the components; wherein an ionic liquid is present in the column.

The present invention relates to an improved process for chemical reaction and separation of a mixture in a column.

It is known that reaction and distillation can advantageously be superimposed in particular cases in processes for chemical reaction and separation of mixtures. This mode of operation is referred to as reactive distillation. It is described in Ullmann's Processes and Process Engineering, Volume 1 (2004), page 259 ff. Advantages are an increase in the conversion in the case of equilibrium-limited reactions and/or an increase in the selectivity. In addition, two apparatuses (reactor and distillation column) can be combined. Overall, there is a saving in energy costs and capital costs. Reactive distillation can be employed when the reaction products are separated off by the distillation and the starting materials are pushed back into the reaction zone. For this to be achieved, the boiling behavior has to be appropriate, i.e. the products either have to be the absolute low boilers or high boilers and the starting materials and also secondary components formed have to be the intermediate boilers.

A disadvantage of this process is that the boiling order fits well enough for the process to be able to be used only in the case of few systems. If, for example, the overhead product forms an azeotrope or is difficult to separate from one of the starting materials, the starting material is taken off overhead together with the product. To obtain pure product, it has to be separated off from the starting material in a subsequent step and recirculated to the reaction section of the column, which costs money.

A relatively new way of obtaining the product in pure form is extractive distillation using ionic liquids. The use of ionic liquids as entrainers frequently makes it possible to achieve very efficient separation of azeotropes or close-boiling mixtures. This leads to less ionic liquid being required compared to conventional entrainers and/or the column being able to be equipped with fewer theoretical plates in order to achieve the same separation performance. Energy costs can also be saved since the total amount of entrainer required is less and the work-up is better because of the high separation factor.

WO 02/074718 discloses a process for the separation of liquids, in which the separation by means of an extractive rectification is improved by the addition of an ionic liquid as entrainer.

Various starting points for combining reactive distillation or reaction with extractive distillation may be found in the literature.

In Jimenez and Costa-Lopez (Industrial & Engineering Chemistry Research (2002), 41(26), 6735-6744), o-xylene is used as entrainer to break the methyl acetate/methanol azeotrope in the transesterification of methyl acetate with n-butanol to form butyl acetate and methanol in the reaction column, According to their own information, this process is not economical.

WO 83/03825 describes the preparation of methyl acetate via the esterification of methanol with acetic acid. The starting material acetic acid simultaneously acts as entrainer in this process. The fact that the acetic acid can be used both as starting material and entrainer is a system-specific coincidence.

In the case of the reaction or separation of mixtures in which the separation factor between a product and a starting material or a secondary component is only relatively small or an azeotrope is present, the effectiveness of known processes in which a reaction and a separation are superimposed is unconvincing. Thus, depending on the specific objective, only relatively low purities can be obtained, undesirable by-products are formed and in some cases complicated separation apparatuses have to be employed, which is, for example, evidenced by the number of theoretical plates required in the column.

We have accordingly found a process for chemical reaction and separation of a mixture in a column, wherein an extractive distillation is at least partially superimposed on a reactive distillation in the column and an ionic liquid is introduced as entrainer into the column. Carrying out a reactive distillation and an extractive distillation simultaneously in a column in the presence of an ionic liquid as entrainer has not only been found to be controllable in process engineering terms but has also been found to be advantageous compared to known, alternative processes.

For the purposes of the present invention, ionic liquids are as defined by Wasserscheid and Keim in Angewandte Chemie 2000, 112, 3926-3945. The group of ionic liquids represents a new type of solvent, As indicated in the publication mentioned, ionic liquids are salts which melt at relatively low temperatures and have a nonmolecular, ionic character. They are liquid even at relatively low temperatures of less than 200° C., preferably less than 150° C., particularly preferably less than 100° C., and have a relatively low viscosity. They have very good solvent capabilities for a large number of organic, inorganic and polymeric substances.

Ionic liquids frequently have a melting point below 0° C., in some cases down to −96° C., which is important for the industrial implementation of extractive rectification.

Furthermore, ionic liquids are generally nonflammable and noncorrosive and have a low viscosity and have no measurable vapor pressure.

For the purposes of the present invention, ionic liquids are compounds which have at least one positive charge and at least one negative charge but are electrically neutral overall.

The ionic liquids can also have a plurality of positive or negative charges, for example from 1 to 5, preferably from 1 to 4, particularly preferably from 1 to 3, very particularly preferably 1 or 2, positive or negative charges, but in particular have one positive charge and one negative charge.

The charges can be present in various localized or delocalized regions within a molecule, i.e. in a betaine-like fashion, or can be present on separate anions and cations. Preference is given to ionic liquids which are made up of at least one cation and at least one anion. Cation and anion can, as indicated above, be singly or multiply charged, but are preferably singly charged.

Of course, mixtures of various ionic liquids or mixtures of conventional entrainers, e.g. N-methylpyrrolidone, N-formylmorpholine, ethylene glycol, propylene glycol, dimethylformamide, ethanediol, benzene, cyclohexane, water, etc., with ionic liquids are also conceivable.

Ionic liquids for the purposes of the present invention are salts of the general formula

[A]ₙ⁺[Y]ⁿ⁻

where n=1, 2, 3 or 4,

or mixed species of the general formula

### [A¹]⁺[A²]⁺ [Y]²⁻, [A¹]⁺[A²]⁺[A³]⁺ [Y]³⁻ or [A¹]⁺[A²]⁺[A³]⁺[A⁴]⁺ [Y]⁴⁻

where A¹, A², A³ and A⁴ are selected independently from the groups mentioned for [A],

or mixed species with metal cations

### [A¹]⁺[A²]⁺[A³]⁺[M¹]⁺ [Y]⁴⁻, [A¹]⁺[A²]⁺[M¹]⁺[M²]⁺ [Y]⁴⁻,

### [A¹]⁺[M¹]⁺[²]⁺[M³]⁺ [Y]⁴⁻, [A¹]⁺[A²]⁺[M¹]⁺ [Y]³⁻, [A¹]⁺[M¹]⁺[M²]⁺ [Y]³⁻,

### [A¹]⁺[M¹]⁺ [Y]²⁻, [A¹]⁺[A²]⁺[M⁴]²⁺ [Y]⁴⁻, [A¹]⁺[M¹]⁺[M⁴]²⁺ [Y]⁴⁻,

### [A¹]⁺[M⁵]³⁺ [Y]⁴⁻, [A¹]⁺[M⁴]²⁺ [Y]³⁻

where M¹, M², M³ are monovalent metal cations, M⁴ are divalent metal cations and M⁵ are trivalent metal cations.

Compounds which are suitable for forming the cation [A]ₙ⁺ of ionic liquids are known, for example, from DE 102 02 838 A1. Thus, such compounds can contain oxygen, phosphorus, sulfur or in particular nitrogen atoms, for example at least one nitrogen atom, preferably from 1 to 10 nitrogen atoms, particularly preferably 1-5 nitrogen atoms, very particularly preferably 1-3 nitrogen atoms and in particular 1-2 nitrogen atoms. Further heteroatoms such as oxygen, sulfur or phosphorus atoms may also be present. The nitrogen atom is a suitable carrier of the positive charge in the cation of the ionic liquid from which a proton or an alkyl radical can then be transferred in equilibrium to the anion to produce an electrically neutral molecule.

In the synthesis of ionic liquids, a cation is firstly produced by quaternization of the nitrogen atom of, for instance an amine or nitrogen heterocycle. Quaternization can be effected by protonation or alkylation of the nitrogen atom. Depending on the protonation or alkylation reagent used, salts having various anions are obtained. In cases in which it is not possible to form the desired anion directly in the quaternization, this is effected in a further synthesis step. For example, starting from an ammonium halide, the halide can be reacted with a Lewis acid to form a complex anion from the halide and Lewis acid. As an alternative thereto, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles is quaternized are C₁-C₁₈-alkyl, preferably C₁-C₁₀-alkyl, particularly preferably C₁-C₆-alkyl and very particularly preferably methyl.

Preference is given to compounds comprising at least one five- or six-membered heterocycle which has at least one nitrogen atom and, if appropriate, an oxygen or sulfur atom; particular preference is given to compounds comprising at least one five- or six-membered heterocycle which has one, two or three nitrogen atoms and a sulfur or oxygen atom, very particularly preferably compounds having two nitrogen atoms.

Particularly preferred compounds have a molecular weight of less than 1000 g/mol, very particularly preferably less than 500 g/mol and in particular less than 250 g/mol.

Furthermore, preference is given to cations selected from among the compounds of the formulae (Ia) to (It),

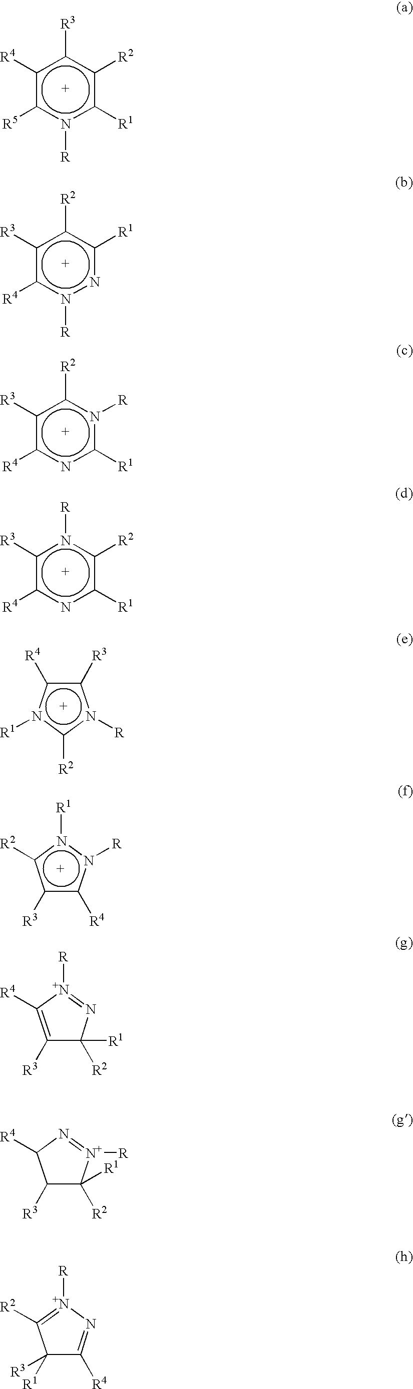

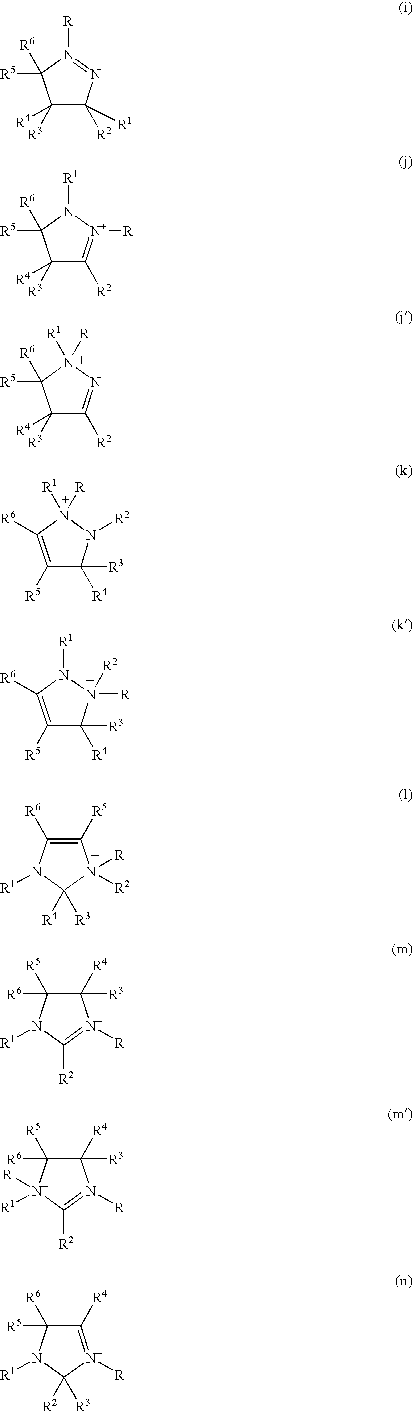

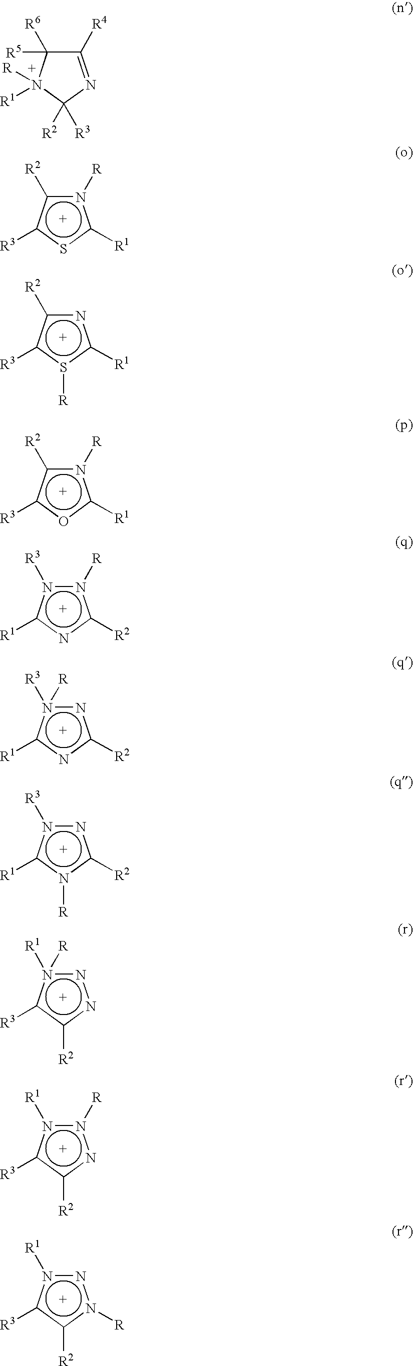

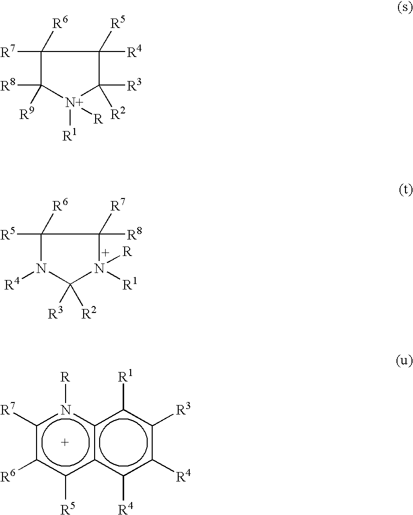

and also oligomers or polymers in which these structures are present, where the substituents and indices have the following meanings:

R is hydrogen or a C₁-C₁₈-alkyl radical, preferably a C₁-C₁₀-alkyl radical, particularly preferably a C₁-C₆-alkyl radical, for example methyl, ethyl, n-propyl, isopropyl, n-butyl, sec-butyl, tert-butyl, n-pentyl (n-amyl), 2-pentyl (sec-amyl), 3-pentyl, 2,2-dimethylprop-1-yl (neopentyl) and n-hexyl, very particularly preferably methyl.

R¹, R², R³, R⁴, R⁵, R⁶, R⁷, R⁸ and R⁹ are each, independently of one another, hydrogen, C₁-C₁₃-alkyl, C₂-C₁₈-alkyl which may be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-containing heterocycle, where two of them may also together form an unsaturated, saturated or aromatic ring which may be interrupted by one or more nonadjacent oxygen and/or sulfur atoms and/or one or more substituted or unsubstituted imino groups, where the radicals mentioned may each be additionally substituted by functional groups, aryl, alkyl, aryloxy, alkyloxy, halogen, heteroatoms and/or heterocycles.

C₁-C₁₈-alkyl which may be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl,

1,1-dimethylpropyl, 1,1-dimethylbutyl, 1,1,3,3-tetramethylbutyl, benzyl, 1-phenylethyl, 2,2-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dinmethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene as fused-on building block.

The number of nonadjacent oxygen and/or sulfur atoms and/or imino groups is in principle not subject to any restrictions or is restricted automatically by the size of the radical or the cyclic building block. In general, it is not more than 5 per radical, preferably not more than 4 or very particularly preferably not more than 3. Furthermore, generally at least one carbon atom, preferably at least two carbon atoms, is/are located between any two heteroatoms.

Substituted and unsubstituted imino groups can be, for example, imino, methylimino, isopropylimino, n-butylimino or tert-butylimino.

For the purposes of the present invention, the term “functional groups” refers, for example, to the following: carboxy, carboxamide, hydroxy, di(C₁-C₄-alkyl)amino, C₄-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropyinaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-containing heterocycle which may be substituted by the appropriate groups is, for example, furyl, thiophenyl, pyrryl, pyridyl, indolyl, benzoxazolyl, dioxolyl, dioxyl, benzimidazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preference is given to R¹, R², R³, R⁴, R⁵, R⁶, R⁷, R⁸ and R⁹ each being, independently of one another, hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, dimethylamino, diethylamino or chlorine.

Particularly preferred pyridinium ions (Ia) are those in which one of the radicals R¹ to R⁵ is methyl, ethyl or chlorine and all others are hydrogen, or R³ is dimethylamino and all others are hydrogen, or all radicals are hydrogen, or R² is carboxy or carboxamide and all others are hydrogen, or R¹ and R² or R² and R³ are together 1,4-buta-1,3-dienylene and all others are hydrogen.

Particularly preferred pyridazinium ions (Ib) are those in which one of the radicals R¹ to R⁴ is methyl or ethyl and all others are hydrogen or all radicals are hydrogen.

Particularly preferred pyrimidinium ions (Ic) are those in which R² to R⁴ are each hydrogen or methyl and R¹ is hydrogen, methyl or ethyl, or R² and R⁴ are each methyl, R³ is hydrogen and R¹ is hydrogen, methyl or ethyl.

Particularly preferred pyrazinium ions (Id) are those in which R¹ to R⁴ are all methyl or all hydrogen.

Particularly preferred imidazolium ions (Ie) are those in which, independently of one another, R¹ is selected from among methyl, ethyl, n-propyl, n-butyl, n-pentyl, n-octyl, 2-hydroxyethyl and 2-cyanoethyl and R² to R⁴ are each, independently of one another, hydrogen, methyl or ethyl.

Particularly preferred pyrazolium ions (If) are those in which, independently of one another, R¹ is selected from among hydrogen, methyl and ethyl, and R², R³ and R⁴ are selected from among hydrogen and methyl.

Particularly preferred pyrazolium ions (Ig) or (Ig′) are those in which, independently of one another, R¹ is selected from among hydrogen, methyl and ethyl and R², R³ and R⁴ are selected from among hydrogen and methyl.

Particularly preferred pyrazolium ions (Ih) are those in which, independently of one another, R¹ to R⁴ are selected from among hydrogen and methyl.

Particularly preferred 1-pyrazolinium ions (ii) are those in which, independently of one another, R¹ to R⁶ are selected from among hydrogen and methyl.

Particularly preferred 2-pyrazolinium ions (Ij) or (Ij′) are those in which, independently of one another, R¹ is selected from among hydrogen, methyl, ethyl and phenyl and R² to R⁶ are selected from among hydrogen and methyl.

Particularly preferred 3-pyrazolinium ions (Ik) are those in which, independently of one another, R¹ and R² are selected from among hydrogen, methyl, ethyl and phenyl and R³ to R⁶ are selected from among hydrogen and methyl.

Particularly preferred imidazolinium ions (Il) are those in which, independently of one another, R¹ and R² are selected from among hydrogen, methyl, ethyl, n-butyl and phenyl and R³ and R⁴ are selected from among hydrogen, methyl and ethyl and R⁵ and R⁶ are selected from among hydrogen and methyl.

Particularly preferred imidazolinium ions (Im) or (Im′) are those in which, independently of one another, R¹ and R² are selected from among hydrogen, methyl and ethyl and R³ to R⁶ are selected from among hydrogen and methyl.

Particularly preferred imidazolinium ions (In) or (In′) are those in which, independently of one another, R¹, R² and R³ are selected from among hydrogen, methyl and ethyl and R⁴ to R⁶ are selected from among hydrogen and methyl.

Particularly preferred thiazolium ions (Io) or (Io′) or oxazolium ions (Ip) or (Ip′) are those in which, independently of one another, R¹ is selected from among hydrogen, methyl, ethyl and phenyl and R² and R³ are selected from among hydrogen and methyl.

Particularly preferred 1,2,4-triazolium ions (Iq) are those in which, independently of one another, R¹ and R² are selected from among hydrogen, methyl, ethyl and phenyl and R³ is selected from among hydrogen, methyl and phenyl.

Particularly preferred 1,2,3-triazolium ions (Ir), (Ir′) or (Ir″) are those in which, independently of one another, R¹ is selected from among hydrogen, methyl and ethyl and R² and R³ are selected from among hydrogen and methyl or R² and R³ together form 1,4-buta-1,3-dienylene and all others are hydrogen.

Particularly preferred pyrrolidinium ions (Is) are those in which, independently of one another, R¹ is selected from among hydrogen, methyl, ethyl and phenyl and R² to R⁹ are selected from among hydrogen and methyl.

Particularly preferred imidazolidinium ions (It) are those in which, independently of one another, R¹ and R⁴ are selected from among hydrogen, methyl, ethyl and phenyl and R² and R³ and also R⁵ to R⁸ are selected from among hydrogen and methyl.

Particularly preferred quinolinium ions (Iu) are those in which, independently of one another, R and R⁷ are selected from among hydrogen, methyl, ethyl, n-butyl, phenyl, octyl and decyl and R¹ to R⁶ are selected from among hydrogen and methyl.

Among the abovementioned heterocyclic cations, the pyridinium ions and the imidazolinium ions are preferred.

Very particular preference is given to imidazolinium ions (Ie) in which R, R¹ and R² are selected independently from among hydrogen, methyl, ethyl and butyl and R³ and R⁴ are each hydrogen.

Further suitable cations are quaternary ammonium ions of the formula (II)

NRR^{a}R^{b}R^{c+} (II)

and quaternary phosphonium ions of the formula (III)

PRR^{a}R^{b}R^{c+} (III).

R^{a}, R^{b} and R^{c} are each, independently of one another, C₁-C₁₈-alkyl, C₂-C₁₈-alkyl which may be interrupted by one or more nonadjacent oxygen and/or sulfur atoms and/or one or more substituted or unsubstituted imino groups, C₆-C₁₄-aryl or C₅-C₁₂-cycloalkyl or a five- or six-membered, oxygen-, nitrogen- and/or sulfur-containing heterocycle or two of them together form an unsaturated, saturated or aromatic ring which may be interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles, with the proviso that at least two of the three radicals R^{a}, R^{b} and R^{c} are different and the radicals R^{a}, R^{b} and R^{c} together have at least 8, preferably at least 10, particularly preferably at least 12 and very particularly preferably at least 13, carbon atoms.

Here, R is hydrogen or a C₁-C₁₈-alkyl radical, preferably a C₁-C₁₀-alkyl radical, particularly preferably a C₁-C₆-alkyl radical, for example methyl, ethyl, n-propyl, isopropyl, n-butyl, sec-butyl, tert-butyl, n-pentyl (n-amyl), 2-pentyl (sec-amyl), 3-pentyl, 2,2-dimethylprop-1-yl (neopentyl) and n-hexyl, very particularly preferably methyl.

Preference is given to R^{a}, R^{b} and R^{c} each being, independently of one another, C₁-C₁₈-alkyl, C₆-C₁₂-aryl or C₅-C₁₂-cycloalkyl, particularly preferably C₁-C₁₈-alkyl, where the radicals mentioned may each be substituted by functional groups, aryl, alkyl, aryloxy, alkyloxy, halogen, heteroatoms and/or heterocycles

Examples of the respective groups have been given above.

The radicals R^{a}, R^{b} and R^{c} are preferably each methyl, ethyl, n-propyl, isopropyl, n-butyl, sec-butyl, tert-butyl, n-pentyl (n-amyl), 2-pentyl (sec-amyl), 3-pentyl, 2,2-dimethylprop-1-yl (neopentyl), n-hexyl, n-heptyl, n-octyl, isooctyl, 2-ethylhexyl, 1,1-dimethylpropyl, 1,1-dimethylbutyl, benzyl, 1-phenylethyl, 2-phenylethyl, α,α-dimethylbenzyl, phenyl, tolyl, xylyl, α-naphthyl, β-naphthyl, cyclopentyl or cyclohexyl.

If two radicals R^{a}, R^{b} and Rform a chain, this can be, for example, 1,4-butylene or 1,5-pentylene.

Examples of tertiary amines from which the quaternary ammonium ions of the general formula (II) are derived by quaternization with the radicals R mentioned are diethyl-n-butylamine, diethyl-tert-butylamine, diethyl-n-pentylamine, diethylhexylamine, diethyloctylamine, diethyl-(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diisopropyl-n-propylamine, diisopropylbutylamine, diisopropylpentylamine, diusopropylhexylamine, diisopropyloctylamine, diisopropyl-(2-ethylhexyl)amine, di-n-butylethylamine, di-n-butyl-n-propylamine, di-n-butyl-n-pentylamine, di-n-butylhexylamine, di-n-butyloctylamine, di-n-butyl-(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred tertiary amines are diisopropylethylamine, diethyl-tert-butylamine, diisopropylbutylamine, di-n-butyl-n-pentylamine, N,N-di-n-butylcyclohexylamine and also tertiary amines derived from pentyl isomers.

Particularly preferred tertiary amines are di-n-butyl-n-pentylamine and tertiary amines derived from pentyl isomers, A further, preferred tertiary amine bearing three identical radicals is triallylamine.

A particularly preferred quaternary ammonium ion is methyltributylammonium.

Further suitable cations are guanidinium ions of the general formula (IV)

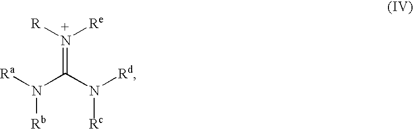

where

R is as defined above,

and the radicals R^{a} to R^{e} are each, independently of one another, a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R^{a} and R^{c} can, independently of one another, also be hydrogen; or

the radicals R^{a} and R^{b} and/or R^{c} and R^{d}, in each case independently of one another, together form a divalent, carbon-containing organic, saturated or unsaturated, acyclic or cyclic, aliphatic, aromatic or araliphatic radical which has from 1 to 30 carbon atoms and may be unsubstituted or interrupted or substituted by from 1 to 5 heteroatoms or functional groups, with the remaining radical/radicals being as defined above; or

the radicals R^{b} and R^{c} together form a divalent, carbon-containing organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups, with the remaining radicals being as defined above. Otherwise, the radicals Ra Re are as defined above for R^{a}-R^{c}.

As anions, it is in principle possible to use all anions. The anion [Y]ⁿ⁻ of the ionic liquid is, for example, selected from among
the group of halides and halogen-containing compounds of the formulae:
   F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻; AsF₆,⁻ ZnCl₃⁻, SnCl₃⁻, CuCl₂⁻, CF₃SO₃⁻, (CF₃SO₂)₂N⁻, CF₃CO₂⁻, CCl₃CO₂⁻, CN⁻, SCN⁻, OCN⁻
the group of sulfates, sulfites and sulfonates of the general formulae:
   SO₄²⁻, HSO₄⁻, SO₃²⁻, HSO₃⁻, R^{a}OSO₃⁻, R^{a}SO₃⁻
the group of phosphates of the general formulae:
   PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
   R^{a}HPO₃⁻, R^{a}R^{b}PO₂⁻, R^{a}R^{b}PO₃⁻
the group of phosphites of the general formulae:
   PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
   R^{a}R^{b}PO₂⁻, R^{a}HPO₂⁻, R^{a}R^{b}PO⁻, R^{a}HPO⁻
the group of carboxylic acids of the general formula:
   R^{a}COO⁻
the group of borates of the general formulae:
   BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)₄⁻, B(R^{a}SO₄)₄⁻
the group of boronates of the general formulae:
   R^{a}BO₂²⁻, R^{a}R^{b}BO⁻
the group of carbonates and carbonic esters of the general formulae:
   HCO₃⁻, CO₃²⁻, R^{a}CO₃⁻
the group of silicates and silicic esters of the general formulae:
   SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
   R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

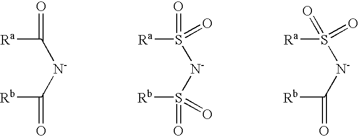

the group of alkoxides and aryloxides of the general formula:
   RaO—
the group of complex metal ions such as Fe(CN)₆³⁻, Fe(CN)₆⁴⁻, MnO₄⁻, Fe(CO)₄⁻

Here, R^{a}, R^{b}, R^{c} and R^{d} are each, independently of one another, hydrogen, C₁-C₁₈-alkyl, C₂-C₁₈-alkyl which may be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-containing heterocycle, where two of them may together form an unsaturated, saturated or aromatic ring which may be interrupted by one or more oxygen and/or sulfur atoms and/or one or more substituted or unsubstituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,1 2-trioxapentadecyl, 9-methoxy-5-oxanonyl, 1,4-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together be, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene as fused-on building block,

The number of nonadjacent oxygen and/or sulfur atoms and/or imino groups is in principle not subject to any restrictions or is restricted automatically by the size of the radical or the cyclic building block. In general, it is not more than 5 per radical, preferably not more than 4 or very particularly preferably not more than 3. Furthermore, generally at least one carbon atom, preferably at least two carbon atoms, is/are located between any two heteroatoms.

Substituted and unsubstituted imino groups can be, for example, imino, methylimino, isopropylimino, n-butylimino or tert-butylimino.

For the purposes of the present invention, the term “functional groups” refers, for example, to the following: carboxy, carboxamide, hydroxy, di(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-containing heterocycle is, for example, furyl thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Particularly preferred anions are chloride Cl⁻, acetate CH₃COO⁻, trifluoroacetate CF₃COO—, triflate CF₃SO₃⁻, sulfate SO₄²⁻, hydrogensulfate HSO₄⁻, methylsulfate CH₃OSO₃⁻, ethylsulfate C₂H₅OSO₃⁻, sulfite SO₃⁻²hydrogensulfite HSO₃⁻, phosphate PO₄³⁻, hydrogenphosphate HPO₄²⁻, dihydrogenphosphate H₂PO₄⁻, carbonate CO₃²⁻, hydrogencarbonate HCO₃⁻, sulfonate, tosylate CH₃C₆H₄SO₃²⁻, bis(trifluoromethylsulfonyl)imide (CF₃SO₂)₂N^{′}, dicyanamide, thiocyanate, tetracyanoborate, salicylate.

Particular preference is given to ionic liquids which have a substituted imidazolium, H-pyrazolium, pyridinium, pyrrolidonium or phosphonium cation as cation.

Particular preference is given to ionic liquids which are not corrosive or even have a passivating action. These include, in particular, ionic liquids having sulfate, phosphate, borate or silicate anions. Particular preference is given to solutions of inorganic salts in ionic liquids and also ionic liquids of the type [A¹]⁺ [M¹]⁺ [Y]⁻ which contain metal cations and have an improved temperature stability. Especial preference is in this case given to alkali metals and alkaline earth metals and salts thereof.

The process of the invention has numerous advantages- as a result of the superimposition of reaction and separation in one column, the conversion in the case of equilibrium-limited reactions can be increased by the removal of one or more products. Depending on the circumstances, complete conversion can be achieved here. The products can be taken off by means of the distillation either overhead or at the bottom. If the separation factor between a product and a starting material or a secondary component is small or an azeotrope is present, the process of the invention has been found to be particularly advantageous: the addition of a suitable ionic liquid as entrainer enables the separation to be lastingly improved.

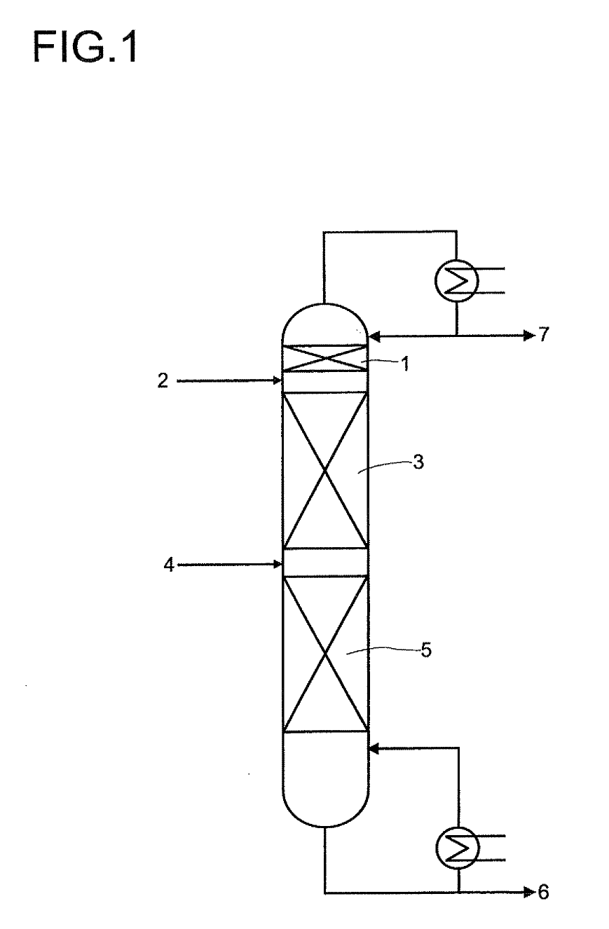

The choice of the ionic liquid which is particularly suitable in a particular case depends on the conditions of the specific separation task and can be determined by a person skilled in the art. The process of the invention thus enables purer product to be taken off at the top of the column. Furthermore, the conversion is increased, since secondary components and starting materials remain in the column and thus in the reaction zone. A further advantage of the process of the invention is that the selectivity can be improved by suppression of reversible secondary reactions. This is achieved by secondary components formed being pushed back into the reaction zone because of their boiling behavior. It is found to be particularly advantageous here that ionic liquids can be separated more selectively than conventional entrainers. Due to their comparably high separation selectivity, they make it possible for a mass stream of entrainer which is smaller compared to conventional entrainers to be introduced into the reactive-extractive distillation and/or for the number of theoretical plates in the column to be reduced. The process of the invention is simpler and cheaper in process engineering terms since reaction or the reactive distillation can be carried out together with the extractive distillation in one column and further work-up of the product streams is either no longer necessary or can be made considerably simpler. In addition, the separation elements 1 in FIG. 1 are no longer necessary since discharge of parts of the ionic liquid via the vapor phase is not possible because of its extremely low volatility. The low vapor pressure also enables the separation of the entrainer from the bottom product to be carried out using various separation operations which offer an advantage in respect of operating and capital costs compared to the second distillation column which is necessary in conventional extractive distillation. A further advantage of the process of the invention is that vaporization energy can be saved in the case of exothermic reactions, since the enthalpy of the reaction is utilized in the column for vaporization.

In addition to purely separation-active ionic liquids, ionic liquids which are also catalytically active may also be suitable for the process of the invention. Acidic or basic ionic liquids in particular are suitable for catalyzing a wide variety of reactions (esterifications, etherifications, hydrogenations) and thus making the process even more effective. The ionic liquid then acts as homogeneous catalyst and is in this case preferably introduced at the top of the column, After having produced its catalytic effect, it leaves the column at the bottom and can easily be separated off from the other components in an evaporation stage since it has no vapor pressure.

The process variant in which the ionic liquid acts both catalytically and as extractant is particularly advantageous. It then accelerates the reaction and at the same time improves the separation performance.

Particularly suitable reactions in which the superimposition of extractive distillation and reaction has a positive effect are, for example, esterifications, transesterifications, etherifications, hydrogenations, dehydrogenations, alkylations, etc. All reactions in which small molecules are liberated and can, owing to their high vapor pressure, be taken off at the top of the distillation column are suitable. Also suitable are reactions which proceed quickly and in which the chemical equilibrium is on the side of the starting materials.

Good catalytic properties are displayed by acidic or basic ionic liquids. Acidic ionic liquids have either an acidic anion such as hydrogensulfate or dihydrogenphosphate or a further acid group in the cation of the ionic liquid, e.g. a sulfonyl group on an alkyl radical of a dialkylimidazolium ion. Basic ILs have basic anions such as acetates.

In an advantageous version of the process, an overhead product which has not yet reached the full final purity is taken off from the first column in which the reaction and extractive distillation occur. This product is passed to a second distillation column and subjected to final purification there. The second column is free of ionic liquid. The low-boiling azeotrope is therefore obtained at the top of the column. The remaining by-products are separated off together with this at the top of the column, and the final product is obtained at the bottom. There, it can either be taken off directly as liquid bottom product or as a gaseous side stream. To minimize losses, the overhead stream from the second column can be recirculated to the first column. In this process variant, the load on the first column is reduced. It can therefore be optimized more readily in terms of the reaction performance and it becomes simpler to regulate.

In the following, the process of the invention is illustrated by way of example with the aid of the figures.

The starting materials are fed in via the feed line (4) of the column in which reactive distillation and extractive distillation occur. It is possible to install an upstream reactor to bring the conversion of the reaction close to the equilibrium composition. The stream (2) is the inflow of ionic liquid (entrainer). The reaction and the desired separation of overhead product and bottom product take place in the presence of the ionic liquid in the elements (3) and (5). Reaction and separation can occur simultaneously or one after the other in the column. Stream (6) is the bottom product stream. Separation elements can be, for example, trays, ordered packing or random packing. The reaction can be homogeneously catalyzed, heterogeneously catalyzed or uncatalyzed. In the case of a heterogeneously catalyzed reaction, the catalyst is present in the elements 3 and/or 5. In the case of a heterogeneously catalyzed reaction, it can also be advantageous for the catalyst to be absent in parts of the elements 3 and 5, i.e. these parts are used as pure separation elements. In the case of a homogeneously catalyzed reaction, the ionic liquid can itself be the catalyst.

The use of ionic liquid as entrainer has the advantage that the vapor pressure of the pure ionic liquid and thus also its partial pressure in the mixture with the overhead product are approximately zero. The separation elements (1) can therefore be dispensed with. The only situation where this is not the case is when volatile impurities which, for example, were not able to be separated off completely on recycling are present in the ionic liquid fed in or when mixtures of ionic liquids with conventional solvents are used as entrainer. To separate these from the overhead product, it may be necessary to have an enrichment section between feed point for the ionic liquid and the top of the column.

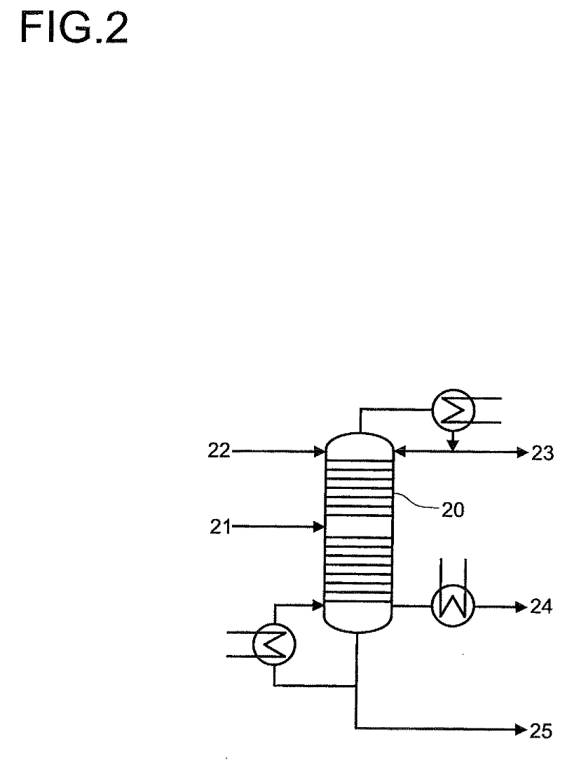

An advantageous variant of the process of the invention is shown by way of example in FIG. 2. The feed is introduced into the column (20) via line (21) and the ionic liquid is introduced via line (22). The overhead stream is taken off via line (23). The entrainer action and, depending on the reaction system, possibly the catalytic action occur on the trays of the column. In the stripping section of the column, the low boiler or boilers (LB) are separated off from the high boiler or boilers (HB) and the ionic liquid (IL), so that there is no longer any low boiler present in the bottom. This can be achieved by a person skilled in the art of distillation by means of a sufficient number of theoretical plates in the stripping section when the IL effects a selectivity of greater than 1.3, which is its task. Since the IL has no vapor pressure, the vapor phase in the bottom consists entirely of high boiler. This is taken off as a gaseous side stream (24). The design of this side offtake and the necessary apparatus is carried out according to the usual rules of distillation and is dependent on the specific separation task in the particular case. Since the separation factor between IL and HB is infinite, one vaporization stage is sufficient to achieve a high purity of HB. In the case of other high-boiling impurities being present or being formed in the bottom or a mixture of IL and conventional solvents having been used as entrainer, further separation elements (side stream column) are necessary.

The high-boiling product is preferably taken off as the side stream in the stripping section close to the bottom, particularly preferably from one of the 3 lowermost theoretical plates, very particularly preferably from the bottom directly at the lowermost theoretical plate.

The optimum quantity of the side stream depends on the permissible temperature in the bottom of the extractive distillation. The larger the stream, the more HB is removed from the stripping section of the column and the less HB is present in the IL and thus in the bottom. The temperature in the bottom rises as a consequence, since the IL has no vapor pressure. Here, the thermal stability of the components in the bottom and the stressability of the material have to be taken into account. The objective is to obtain a very low HB content in the IL without thermal damage. Depending on the mixture and the operating pressure, the permissible temperature at the bottom can be from 50° C. to above 200° C. It is preferably in the range from 100 to 200° C. Owing to the thermal stability of customary ionic liquids, a temperature of 250° C., preferably 200° C., should not be exceeded. A further aspect to be considered in the optimization of the temperature at the bottom is the energy consumption. As the temperature at the bottom increases, the energy consumption also rises since the ionic liquid has to be heated and then cooled down again before it can be recycled to the top of the column.

The content of HB in the IL can be decreased greatly by means of the side stream. Contents of HB in the IL of less than 10%, preferably less than 5%, particularly preferably less than 1%, can be achieved, with the achievable values depending on pressure and permissible temperature in the bottom of the column. Apart from the high temperature, a high vapor pressure of the HB and a low column pressure are advantageous for depletion of the HB from the IL. The concentrations reported are, unless indicated otherwise, by mass, i.e. % is percent by weight and ppm is ppm by weight.

If the HB is to be obtained as liquid product, the gaseous side stream is liquefied by means of an additional condenser.

The bottom stream is conveyed from the column (20) by means of line (25). Further high boiler still present in this mixture can be separated off in subsequent process steps such as evaporation and/or stripping.

The process of the invention makes it possible, due to the side stream, for the high boiler to be depleted in the bottom stream from the column. This depletion can in some cases be sufficient in terms of quality for the stream which is rich in ionic liquid obtained at the bottom to be recirculated directly to the top of the column for the ionic liquid to be reused as entrainer.

For economic reasons, the ionic liquid should be circulated, i.e. HB remaining in the IL is conveyed together with the latter to the top of the extractive rectification. There, part of the HB will go into the vapor phase and contaminate the overhead product (LB). If the purity requirements for the LB are moderate, then depletion of the HB in the IL as a result of the gaseous side stream alone is sufficient and no further work-up of the IL is necessary. In this particularly advantageous variant, the extractive-reactive distillation can be carried out in one column. Compared to a normal reaction followed by an extractive distillation, which always requires a second column for working up the entrainer, this means an appreciable simplification of the process and considerable capital costs savings.

In the case of higher requirements or not yet satisfactory depletion of high boiler in the bottom stream, a further work-up of this stream before it is recirculated to the column can be advisable in order to counter undesirable contamination of the overhead product. For this purpose, this bottom stream which has been taken off is fed into an evaporator and/or a stripping column in which the concentration of residual high boilers still present is reduced further. The ionic liquid obtained in this way is subsequently returned to the column. The great advantage of this process variant is that the high boiler content of the IL can be significantly reduced by means of the side stream and subsequent removal of the residual high boiler from the IL is made easier. If, for example, an evaporator stage under reduced pressure is used to separate off the residual high boilers from the IL, the higher boiler vapors have to be condensed at this reduced pressure. If the recirculated IL has to meet high purity requirements, the temperature has to be high and at the same time the pressure has to be very low so that the high boiler evaporates from the IL. Very low temperatures in the condenser are then necessary to condense the high boiler vapor and compress it to ambient pressure. A refrigeration machine is usually necessary to achieve quantitative condensation. Since refrigeration energy is more expensive than cooling water, it is cheaper to condense the high boiler in the condenser of the side stream than in the condenser of the downstream evaporator under reduced pressure. A similar situation applies to the separation of the high boiler from the IL by stripping with inert vapor. This version, too, enables the IL to be purified to very low high boiler contents. The greater the high boiler content, the more inert gas is necessary. Large heat exchanger areas are necessary to condense the high boiler from the inert gas and a refrigeration machine also becomes necessary here if the losses of high boiler are to be low. It is therefore simpler to pass the high boiler together with the inert gas to incineration or, if possible, discharge it into the environment (HB=water). It is therefore advantageous to take off the major part of the high boiler via the side stream and to dispose of the proportion of high boiler obtained in the fine purification of the ionic liquid.

### EXAMPLES

### Example: Reactive-Extractive Distillation of Methanol and Boric Acid to Form Trimethyl Borate and Water

Description of the Apparatus

The experimental apparatus comprised a thin film evaporator made of glass which had a distillation column (height: 5 m, diameter: 30 mm) fitted on top. The column comprised 5 glass sections each having 14 bubble cap trays. The column was provided with thermocouples at regular intervals, so that the temperature could be measured on every third or fourth tray except for the bottom and top of the column. In addition to the temperature profile, the concentration profile in the column could be determined by means of appropriate sampling points. The feed solution was fed in under mass flow regulation from a reservoir standing on a balance. The evaporator had a holdup of about 100 ml and was heated by means of a thermostat. The stream discharged at the bottom was pumped into a container on a balance and from there into a second thin film evaporator (TFE). In the TFE, the volatile components were vaporized at high temperatures under reduced pressure and condensed in a downstream condenser cooled by means of a cryostat. The stream discharged at the bottom of the TFE was recirculated to the uppermost theoretical plate of the distillation column after it had been cooled down to the temperature of the uppermost theoretical plate. The distillate from the distillation column was condensed out in a condenser cooled by means of cooling water, collected in a collection vessel and from there partly returned as runback to the column and partly discharged in a regulated manner via a balance. All inflowing and outflowing steams and the measured temperatures and pressures were recorded continuously by a process control system. The apparatus was operated around the clock to achieve steady-state conditions.

Experiment Procedure

Boric acid and methanol (MeOH) were fed in as feed stream and reacted in the distillation column to form trimethyl borate (TMB) and water. The boric acid was dissolved in methanol beforehand in the reservoir. A weight ratio of boric acid to methanol of 1:4 was set. The methanol was added in excess in the feed, firstly to dissolve the boric acid (BA) present as solid and secondly to ensure complete conversion of the boric acid. The flow rate of the feed stream was 220 g/h and the stream was introduced on the 35th tray. The ionic liquid (IL) was introduced at the top of the column at a mass flow rate of 500 g/h and washed MeOH and water downward. The low-boiling azeotrope of TMB and MeOH was broken in this way and TMB was obtained as virtually pure distillate. The distillate purity was 99.3% TMB. The distillate flow was 77 g/h and the runback was 600 g/h. At the top of the second TFE, 140 g/h of a stream comprising 73% of methanol and 27% of water were taken off. The proportion of TMB in this stream was below 0.01%. The boric acid was reacted completely in the column. The thin film evaporator for purifying the IL was operated at 50 mbar and a temperature of 175° C. The pressure in the distillation column was 1 bar.

### Example: Transesterification of Ethyl Acetate to Form Methyl Acetate

Reaction Equation:

Ethyl acetate+methanol<=>methyl acetate+ethanol

Azeotrope:

Ethyl acetate/ethanol, methyl acetate/methanol

IL: MIAHSO4—methylimidazolium hydrogensulfate

The same apparatus was used. The feed was fed in at 400 g/h and comprised 27% of MeOH and 73% of ethyl acetate. The temperature of the feed was 71.5° C. 370 g/h of IL (MIHSO4) were introduced at the top of the column. The reflux ratio was 1.5. Methyl acetate having a purity of 99.9% was able to be obtained at a flow rate of about 247 g/h at the top of the column. The temperature in the condenser was about 57° C. A mixture of about 29% of ethanol and 71% of IL was obtained at the bottom of the column (1st thin film evaporator) at about 92° C. At the top of the 2nd thin film evaporator (50 mbar), 153 g/h of ethanol having a purity of 99.9% could be isolated from the IL. The recirculated IL still contained small amounts of low boilers (130 ppm of ethanol, 50 ppm of ethyl acetate, 50 ppm of methanol) as impurities. The second thin film evaporator had a mean heating temperature of 165° C.

Result:

The IL breaks the methyl acetate/methanol azeotrope so that methyl acetate can be obtained overhead in pure form. At the same time, it catalyzes the transesterification as acidic IL. Virtually no ethyl acetate is detected in the bottom of the second thin film evaporator. The IL makes ethanol the high boiler in the bottom, so that it can be taken off in vapor form via the bottom. The equilibrium of the reaction is shifted strongly to the side of methyl acetate, since both products can be taken off and the starting materials are pushed back into the reaction zone. The conversion is close to 100%.

1-12. (canceled)

13. A process comprising: (a) providing one or more reactants to a column; and (b) carrying out at least partially superimposed reactive distillation and extractive distillation on the one or more reactants in the column to form a reaction product mixture comprising at least two components and separate at least one of the components; wherein an ionic liquid is present in the column.

14. The process according to claim 13, wherein the reactive distillation and the extractive distillation are carried out continuously with the removal of at least one of the components from the reaction product mixture during the continuous reaction.

15. The process according to claim 13, wherein the ionic liquid comprises a reaction catalyst.

16. The process according to claim 14, wherein the ionic liquid comprises a reaction catalyst.

17. The process according to claim 13, wherein the ionic liquid is introduced at the top of the column.

18. The process according to claim 14, wherein the ionic liquid is introduced at the top of the column.

19. The process according to claim 16, wherein the ionic liquid is introduced at the top of the column.

20. The process according to claim 13, wherein at least one of the at least two components in the reaction product mixture comprises a high boiler and the high boiler is removed from the column in vapor form as a side offtake.

21. The process according to claim 14, wherein at least one of the at least two components in the reaction product mixture comprises a high boiler and the high boiler is removed from the column in vapor form as a side offtake.

22. The process according to claim 19, wherein at least one of the at least two components in the reaction product mixture comprises a high boiler and the high boiler is removed from the column in vapor form as a side offtake.

23. The process according to claim 13, wherein the ionic liquid is present in amounts of IO to 90% by weight in the column between an introduction point for the ionic liquid and a feed point for the one or more reactants.

24. The process according to claim 14, wherein the ionic liquid is present in amounts of 10 to 90% by weight in the column between an introduction point for the ionic liquid and a feed point for the one or more reactants.

25. The process according to claim 19, wherein the ionic liquid is present in amounts of 10 to 90% by weight in the column between an introduction point for the ionic liquid and a feed point for the one or more reactants.

26. The process according to claim 22, wherein the ionic liquid is present in amounts of 10 to 90% by weight in the column between an introduction point for the ionic liquid and a feed point for the one or more reactants.

27. The process according to claim 13, further comprising subjecting an overhead product from the column to a fine purification distillation in a second column.

28. The process according to claim 27, wherein an overhead product from the second column is introduced into the first column.

29. The process according to claim 13, wherein the reactive distillation comprises a condensation reaction.

30. The process according to claim 13, wherein the reactive distillation comprises an esterification reaction.

31. The process according to claim 13, wherein the reactive distillation comprises an etherification reaction.

32. The process according to claim 13, wherein the reactive distillation comprises a dehydrogenation or hydrogenation reaction.
